(19) United States
(12) Patent Application Publication
(10) Pub. No.: US 2015/0366166 A1
(43) Pub. Date: Dec. 24, 2015

(54) PET MONITORING DEVICES

(71) Applicant: Binatone Electronics International Ltd, Hong Kong (HK)

(72) Inventor: Karl-Heinz MUELLER, Hong Kong (HK)

(73) Assignee: Binatone Electronics International Ltd, Hong Kong (HK)

(21) Appl. No.: 14/319,535

(22) Filed: Jun. 30, 2014

(30) Foreign Application Priority Data
Jun. 23, 2014 (GB) GB 1411156.1

(51) Int. Cl. A01K 29/00; H04W 4/02

(52) U.S. Cl. CPC A01K 29/005; H04W 4/02

(57) ABSTRACT

A pet monitoring device 12 to be fitted to a pet 14 that is to be monitored includes a transmitter configured to transmit signals via a mobile telecommunications network 20. The location of the pet monitoring device 12 can be determined by reference to parameters associated with receipt of a signal 18 transmitted by the transmitter by at least one base station of the mobile telecommunications network 20 so that an authorised user can identify the location of the pet monitoring device.

### CROSS-REFERENCE TO RELATED APPLICATIONS

This application claims benefit of and priority to the following patent application which is hereby incorporated in its entirety by reference: GB1411156.1 filed Jun. 23, 2014.

### FIELD OF THE INVENTION

The invention relates to pet monitoring devices.

### BACKGROUND TO THE INVENTION

Pets such as dogs and cats may at times roam free. This may be intentional or by accident. For example, an owner may take a dog to a park or the like for exercise. Once at the park, the owner may release the dog from the leash, or lead, that would typically be used to keep the dog under control while journeying to the park. Once the dog has been released from the lead, the owner has to rely on verbal commands as a means of controlling the dog and cannot use the lead to restrain the dog or to provide corrective physical reminders to the dog concerning its behaviour. Once released from the lead, a dog may run off and the owner may not be able to keep the dog in sight. Alternatively, a dog may escape from a garden, its home or the like in which it is free to roam. In these circumstances, an owner may find it useful to be able to locate the whereabouts of the dog to avoid having to search for the dog. Similarly, if a cat or other such pet is missing, the owner may wish to be able to locate the pet without having to carry out a search of the neighbourhood.

### SUMMARY OF THE INVENTION

The invention provides a pet monitoring device as specified in claim 1.

The invention includes a pet monitoring device as specified in claim 15.

The invention also includes a pet monitoring system as specified in claim 17.

The invention also includes a method of monitoring a pet as specified in claim 24.

### BRIEF DESCRIPTION OF THE DRAWINGS

In the disclosure that follows, reference will be made to the drawings in which:

FIG. 1 is a schematic representation of a pet monitoring system;

FIG. 2 is a schematic representation of a pet monitoring device of the pet monitoring system of FIG. 1;

FIG. 3 is an end elevation of the pet monitoring device of FIG. 2; and

FIG. 4 is a side elevation of the pet monitoring device looking in the direction of the arrow IV in FIG. 3.

### DETAILED DESCRIPTION

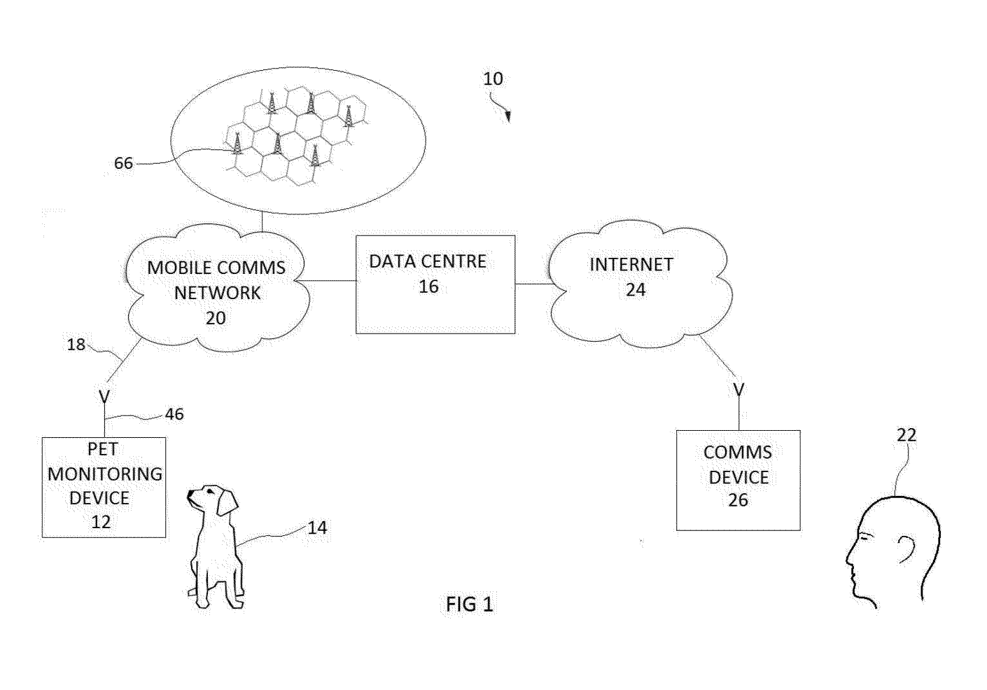

Referring to FIG. 1, a pet monitoring system 10 comprises a pet monitoring device 12 to be fitted to a pet 14 that is to be monitored and a data centre 16. The pet monitoring device 12 comprises a transmitter that is configured to transmit signals 18 via a mobile telecommunications network 20. The data centre 16 is configured to receive data from those signals 18 and provide an authorised user 22 with access to data associated with the pet monitoring device 12. The authorised user 22 may access the data from the data centre 16 via the internet 24 using a suitably enabled communications device 26 such as a personal computer (PC), personal digital assistant (PDA), tablet, smartphone or the like. The communications device 26 may access the internet 24 by a wired or wireless connection. The authorised user 22 will typically be the pet's owner. Although not limited to this, in the examples described herein, the pet monitoring device 12 comprises a dog collar that can be secured around the neck of a dog.

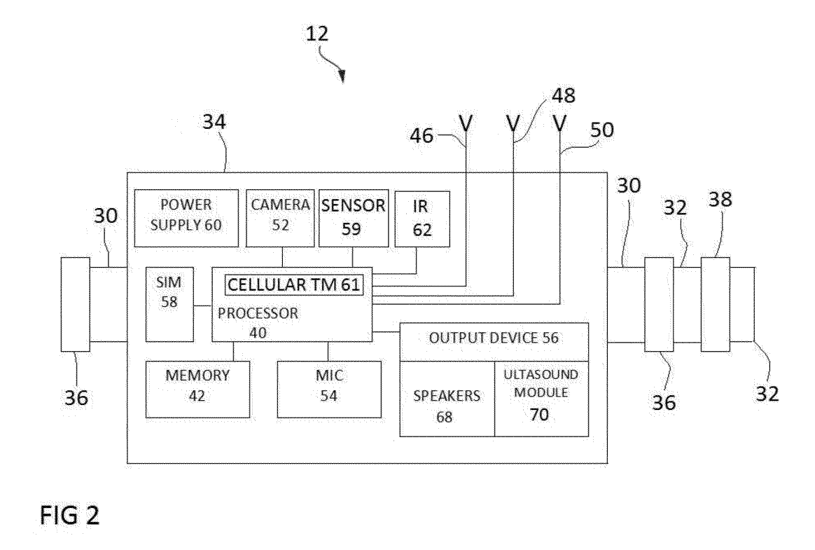

Referring to FIGS. 2 to 4, the pet monitoring device 12 includes a collar comprising collar portions 30, 32. The collar is connected to opposite sides of a housing, or main body portion, 34. The collar portions 30, 32 are connected to one another by connectors 36 that allow the length of the collar to be adjusted to fit a pet that is to wear the pet monitoring device 12. The size of the collar can be adjusted by operation of a size adjustment control 38 that is operable to adjust the collar length. It is to be understood that the collar structure shown in FIGS. 2 to 4 is not essential. In principle, the housing 34 may be configured such that it can be secured to a pet by other known forms of collar.

Referring to FIG. 2, the pet monitoring device 12 may comprise a processor 40, memory 42 (for example an SD card), a cellular telephone antenna 46, a GPS antenna 48, an RF signal antenna 50 capable of WIFI or Bluetooth® reception, an image capturing device 52, a sounds capturing device 54, a stimulus output device 56 to output stimuli to the pet, a mounting for a SIM card 58 and a bark sensor module 59, which are all mounted in or on the main body portion 34. Although not essential, the SIM card 58 may be preinstalled.

The pet monitoring system 12 additionally comprises a power supply module 60. The power supply module 60 may comprise a battery and a power management controller. The power supply module 60 is suitably electrically connected to the various components of the pet monitoring device that require electrical power, such as the processor 40, image capturing device 52, sounds capturing device 54 and stimulus output device 56. The power management controller is configured to ensure that a suitable supply of electricity is delivered to such components. For the sake of clarity of the drawing, the electrical connections are not shown in FIG. 2 and since the provision of such electrical connections is something that will be familiar to those skilled in the art, they will not be described in detail herein. The battery may be rechargeable. Recharging may be by way of connection to an external power source via a plug and socket (not shown) similar to the plug and socket charging arrangements used for recharging the batteries of smartphones and the like. Alternatively, or additionally, the power supply 60 may include a battery recharger module configured as an RF charger or a kinetic charger. Additionally, or alternatively, the battery may be rechargeable by solar charging.

In many examples, separate control modules or circuitry may be provided to control the components such as the image capturing device 52, the sounds capturing device 54 and the output device 56, each such control module or circuitry being connected, or interfacing, with the processor 40 to enable the processor to have overall control of the pet monitoring device 12. However, in the illustrated example, the processor 40 is configured to function as a direct component controller for each of those components and incorporates suitable codecs and signal processing capability to interface with such components. Similarly, the cellular telephone antenna 46 may be connected with a separate cellular telephone module that is connected with the processor 40 or, as in the illustrated example, the cellular telephone module, or transmitter, 61 may be incorporated in the processor. The pet monitoring device 12 is shown having separate antennae 46, 48, 50. However, the processor 40 may be configured to support at least one multi-purpose antenna, for example, a single antenna for Bluetooth®, WLAN and GPS. One processor supporting direct component control functions and a multi-purpose antenna as described above is Media Tek Inc's MT6572W WCDMA Smartphone application processor. The pet monitoring device 12 may be implemented by running an Android® operating system using Android services for mobile connection and control of the device functions on a processor with direct component control capability, such as the above-mentioned Media Tek processor.

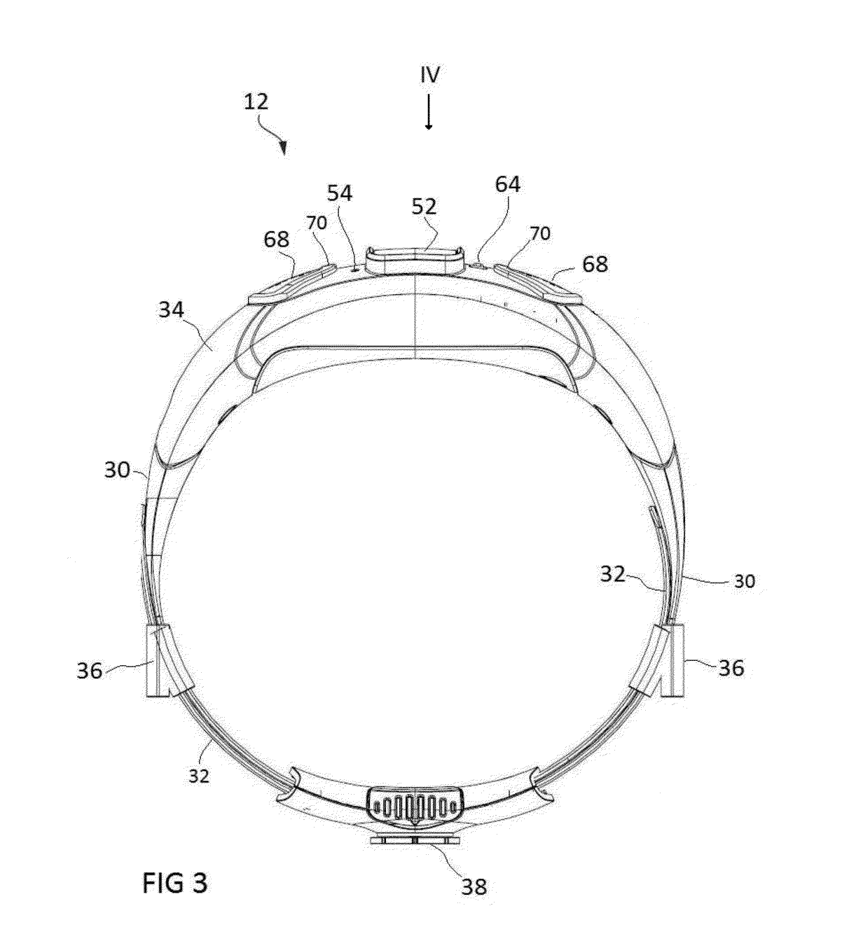

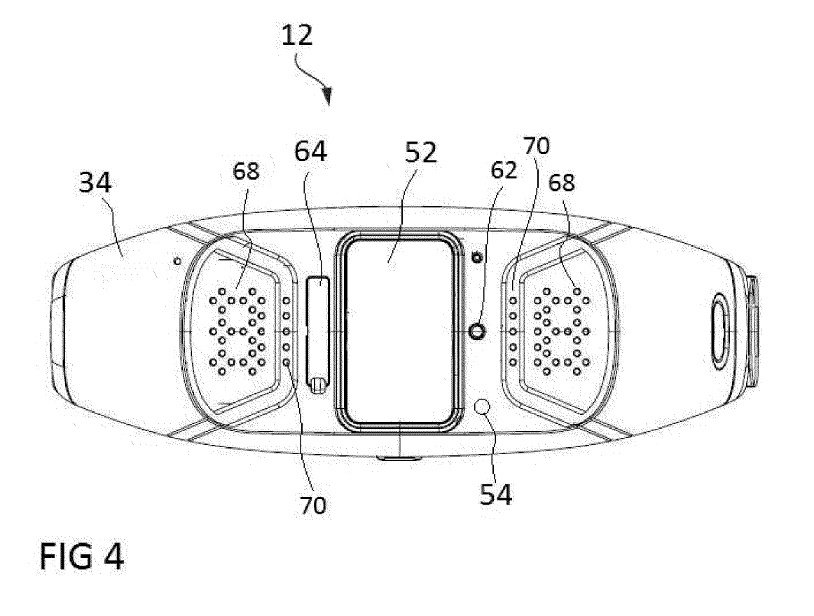

Referring to FIGS. 3 and 4, the image capturing device 52 may be a camera capable of capturing still or video images. The image capturing device 52 may be controllable to selectively provide still or video images according to pre-programmed criteria or in response to commands from the authorised user 22. The pet monitoring device 12 may be provided with a closure 64 such as a door, flap or the like to provide access to an adjustment mechanism (not shown) by means of which the camera angle can be adjusted. The processor 40 may be configured to receive signals from the image capturing device 52 and generate data packets containing data representative of the captured images. The processor 40 may be configured to cause the data packets to be transmitted to the data centre 16 over the mobile telecommunications network 20 via the cellular telephone antenna 46. The data may be representative of still images or video images. The processor 40 may be configured to cause data representative of the captured images to be stored in the memory 42. The pet monitoring device 12 may be provided with an IR lighting device 62 to provide a night vision capability. Although shown separately in the drawings, the IR lighting device 62 may be an integral part of the image capturing device 52.

The sounds capturing device 54 may comprise one or more microphones. The processor 40 may be configured to receive signals from the sounds capturing device 54 and generate data packets containing data representative of the captured sounds. The processor 40 may be configured to cause the data packets to be transmitted to the data centre 16 over the mobile telecommunications network 20 via the cellular telephone antenna 46. The processor 40 may be configured to store data representative of the captured sounds in the memory 42. In the illustrated example the image and sounds capturing devices 52, 54 are shown as separate devices. In other examples, the sounds capturing device may be an integral part of the image capturing device.

The processor 40 may be configured to process the captured images and sounds to provide data packets containing combined image and sound data or data packets containing just image or sounds data according to predetermined circumstances. Thus, for example, for the purposes of a bark alarm, the data packets sent may comprise just data representative of captured sound and for a quick enquiry mode, data representative of a still image rather than video or sound. In cases in which the pet is lost, the data packets may comprise data representative of combined image and sound thereby providing more information to facilitate searching. By limiting the amount of data sent to just sound or still image data, it is possible to limit the time spent accessing the mobile telecommunications network 20, thereby potentially saving on cost and on the amount of power drawn from the power supply 60.

The processor 40 may be configured to determine the location of the pet monitoring device 12 by utilising GPS data received via the GPS antenna 48. The processor 40 may use GPS or A-GPS tracking techniques to determine the location of the pet monitoring device 12. The processor 40 may be configured to cause data packets containing coordinates that identify the location of the pet monitoring device 12 to be transmitted over the mobile telecommunications network 20. Alternatively, the data packets may contain GPS data that can be manipulated downstream of the pet monitoring device 12 to identify its location.

The location of the pet monitoring device 12 may additionally be identified by utilising data derived from signalling to the mobile telecommunications network 20 via the cellular telephone antenna 46. It is not necessary for the pet monitoring device 12 to be transmitting data for this method to be used. The location can be determined if the cellular telephone antenna 46 simply transmits a roaming signal to contact the next nearby base station, or antenna tower, 66 of the mobile telecommunications network 20. In some examples, an approximation of the location of the pet monitoring device 12 may be based on identifying the closest base station 66 and the relative position of the pet monitoring device. In other examples, the location may be determined using parameters associated with the receipt of transmitted signals by a plurality of base stations 66. The determination may be based on a comparison of parameters such as:
i) the angle of approach of the signal to the base station(s);
ii) how long it takes the signal to travel to the base station(s); and
iii) the strength of the signal received by the base station(s).

The comparison technique may comprise a multilateration technique such as triangulation using one or more parameters associated with the receipt of the transmitted signals by a plurality of the base stations 66. The processor 40 may be configured to cause data packets containing coordinates that identify the location of the pet monitoring device 12 to be transmitted over the mobile telecommunications network 20. Alternatively, the data packets may contain signal parameter data that can be manipulated downstream of the pet monitoring device 12 to identify its location.

The stimulus output device 56 may comprise one or more speakers 68 or one or more ultrasound emitters 70. Although not essential, the illustrated pet monitoring device 12 has both. The cellular telephone antenna 46 and processor 40 may be configured to allow the receipt of signals containing data representative of commands sent over the mobile telecommunications network 20 by the authorised user 22. The processor 40 may be configured to cause the speakers 68 or ultrasound emitters 70 to output stimuli to the pet in response to the commands sent by the authorised user 22. The output may, for example, comprise instructions spoken by the authorised user 22, such as a command to ‘sit’ ‘stay’ or ‘stop barking’. The data necessary to provide the spoken output from the speakers may be stored in the memory 42. In this case, the commands sent by the authorised user 22 may comprise a relatively brief identifier that allows the processor 40 to identify the stored instruction that is to be output. In some examples, the incoming data may comprise data sufficient to enable instructions spoken in real time to be output from the speakers 68. In this case, the spoken instructions output from the communications device 26 may be transmitted to the pet monitoring device 12 using Voice-over-Internet protocol (VoIP) methodology so that the signals transmitted to the pet monitoring device 12 can be restricted to signals that primarily contain just compressed data, thus economising on the time spent accessing the mobile telecommunications network 20.

The commands sent by the authorised user 22 may cause the processor 40 to cause the ultrasound emitters 70 to emit sounds intended to encourage the dog to cease barking. The processor 40 may be configured to cause the ultrasound emitters 70 to emit different patterns of sounds in response to respective commands received from the authorised user 22.

The bark sensor module 59 may comprise a three axis gravity sensor. The bark sensor module 59 may comprise a processor or suitable circuitry configured to monitor and analyse the output of the sensor to determine whether the dog is barking. Alternatively, the processor 40 may be configured to process the output from the bark sensor module 59 to determine whether the dog is barking. The sensor output may be monitored to detect certain patterns, or frequencies, that indicate the dog is barking. The processor 40 may be configured to respond to a detection that the dog is barking by causing an alert to be sent to the data centre 16 via the mobile telecommunications network 20 for notification to the authorised user 22. In this case, the authorised user 22 may decide to take action to try and cause the dog to cease barking. The authorised user 22 may cause a signal containing a suitable command to be transmitted over the mobile telecommunications network 20 to cause the output of a stimuli from the output device 56 that is intended to encourage the dog to cease barking. The signal may contain data the processor 40 uses to determine which of one or more predetermined stimuli should be output. For example, the signal may contain data that the processor 40 determines should cause the output of a particular recorded voice instruction via the speakers 68. Alternatively, the processor 40 may determine that the command is to cause a predetermined output from the ultrasonic emitters 70. As another alternative, the data may contain real time spoken commands that the processor 40 causes to be output via the speakers 68. Additionally, or as an alternative to alerting the authorised user 22 to a detection of the dog barking, the processor 40 may be configured to immediately cause the output of one or more stimuli from the output device 56 to encourage the dog to cease barking. Automatic output of one or more stimuli may be in accordance with pre-programmed criteria.

The data centre 16 may comprise one or more servers, or space reserved on one or more servers, maintained by the mobile telecommunications network 20. Alternatively, the data centre 16 may comprise a computing facility such as one or more servers, or electronic data storage devices, maintained by a separate service provider. The service provider may be an entity providing a dedicated service for owners of pet monitoring devices 12. In either case, the processor 40 is configured to append indentifying data to the signals it transmits so that the data centre 16 can associate the data packets with the authorised user 22. The data centre 16 may store the data packets in an appropriate location in the data centre that can be accessed by the authorised user 22. The data centre 16 may further comprise a processing capability that enables the sending of alerts, or notifications, to the authorised user 22 in response to transmissions received from the pet monitoring device 12 and forwarding commands from the authorised user to the pet monitoring device via the mobile communications network 20. The processing capability of the data centre 16 may be configured to forward data packets to the authorised user. The alerts or data packets transmitted to the authorised user 22 may, for example, comprise SMS messages, automated telephone messages or emails.

The pet monitoring device 12 and associated services may be configured to allow the authorised user 22 to access data transmitted by the pet monitoring device and held in the data centre 16 by means of a suitably enabled communications device 26 such as a personal computer (PC), personal digital assistant (PDA), tablet, smartphone or the like. The communications device 26 may access data held in the data centre 16 via a wired or wireless connection to the internet 24. Access to the data associated with the pet monitoring device 12 may be password protected. Alternatively, or additionally, access may be allowed by means of a suitable smartcard or certificates issued to the authorised user and stored on the communications device 26. The use or such smartcards or certificates for, for example, accessing bank accounts, will be known to those skilled in the art and so will not be described in detail herein. Whatever form of protection, or access authorisation, is provided for the data in the data centre 16, the arrangement will be such that the authorised user 22 can only access data relating to the pet monitoring device(s) 12 the authorised user has been authorised to access.

The data packets transmitted by the pet monitoring device 12 and the means of transmission from the data centre 16 may be configured such that the authorised user 22 does not have to add any new software to the communications device 26 in order to display the location of the pet monitoring device 12, captured still or video images or captured sound. The data representative of the location of the pet monitoring device 12 may be configured such that the authorised user 22 can display the location on the communications device 26 by opening a browser and accessing Google Maps™. Similarly, still images may display using utilities such as Microsoft's Windows Photo Viewer and video images and sound may be accessed using a program such as RealPlayer® or Windows Media Player®.

In some examples, software or an app may be supplied, which the authorised user 22 can load onto the communications device 26 to provide additional functionality. For example, the software or app may enable the authorised user 22 to connect directly to the pet monitoring device 12 to set up, or adjust, user controllable features of the pet monitoring device. Direct connection to the pet monitoring device 12 may be over the internet 24 via the RF signal antenna 50 or by Bluetooth® connection via the antenna 50. The software or app may also enable the authorised user 22 to connect to the data centre 16 to set up an account, activate the service or set user functions to determine how the data packets and signals received from the pet monitoring device 12 are processed.

The software or app may enable the authorised user 22 to use the communications device 26 to upload data to the pet monitoring device 12. For example, the user may upload recordings of a human voice the pet will recognise. Recordings for a dog may comprise instructions such as ‘sit’, ‘stay’ or ‘cease barking’. In examples in which the pet monitoring device 12 comprises a bark sensor module 59, the software or app may enable the authorised user 22 to use the communications device 26 to tune the bark detection module 59 to the increase the likelihood of accurate detection of barking and reduce the likelihood of false alarms. The software or app may cause the presentation of a menu or menus on the communications device 26 to facilitate these operations. A menu may be enabled that allows the authorised user 22 to select whether an alert is to be transmitted from the pet monitoring device 12 when barking is detected or the processor 40 should simply cause the output or one or more stimuli from the stimulus output device 56 to encourage the dog to cease barking. The software or app may enable the authorised user 22 to configure the pet monitoring device 12 to store data defining a boundary, or virtual fence, within which the dog is permitted to roam and how the pet monitoring device 12 is to respond to a detection that the dog has strayed beyond the boundary. The authorised user 22 may be enabled to select how often the pet monitoring device 12 checks to see whether the dog has strayed beyond the boundary. Frequent checks may make it easier for the authorised user to find and collect the dog, while less frequent checks will involve draining less power from the power supply module 60. It will be understood that such checks can be made by the processor 40 using GPS, A-GPS or the multilateration techniques mentioned above to determine the current location of the pet monitoring device 12 and compare that with data representative of the boundary that is stored in the memory 42.

The software or app may enable the authorised user 22 to select how long or far the dog may roam outside of the boundary before triggering action. This may be advantageous if straying outside of the boundary is short lived as it will avoid the sending of unnecessary alerts to the authorised user, thus saving on power and network access time, and the unnecessary application of behaviour stimulants to the dog.

The software or app may enable the authorised user 22 to determine how a detection of straying beyond the boundary is to be handled. The authorised user 22 may be presented with a menu enabling a selection to be made. For example, the authorised user may be able to select whether image or sound data is transmitted in cases in which coordinates identifying the location of the pet monitoring device 12 obtained by GPS, A-GPS or multilateration are available. Image and sound data may be considered superfluous if the authorised user 22 has the location of the dog located on a map displayed on the communications device 26. However, the authorised user 22 may still want to receive images and or sound as this may make it possible to judge the mood of the pet and in consequence be willing to accept the additional drain on power from the power supply module 60 and additional network usage on the mobile communications network 20.

The software or app may enable the authorised user 22 to configure the pet monitoring device 12 so that it will only attempt to determine its location in response to an enquiry from the authorised user received via the mobile telecommunications network 20. This may result in reduced usage of the pet monitoring device 12 as location detection will only be implemented if the authorised user 12 wishes to ascertain the location of the pet, perhaps because it is believed the pet has strayed or is lost. The authorised user 22 may also be given the possibility of selecting how the pet monitoring device 12 operates in response to an enquiry as to its location. For example, the authorised user 22 may be able to determine that a check is made first using GPS tracking, if that fails multilateration is used and if that fails images or sounds are captured to facilitate identifying the location. Thus, the authorised user 22 may be able to programme a detection sequence.

In use, the authorised user 22 can fit the pet monitoring device around the neck of the pet such as a dog 14 that is to be monitored and use the size adjustment control 38 to adjust the collar to make a comfortable fit. The authorised user 22 can then access the pet monitoring device 12 from a communications device 26 via a WIFI or Bluetooth® to setup an account at the data centre 16 and activate the service. The SIM card 58 is activated on first usage. The authorised user 22 may load a supplied app or software onto the communications device 26 to facilitate access to the pet monitoring device 12 or the data centre 16. During the setup procedure, some of which can be undertaken at a later date, the authorised user 22 can adjust various settings to, for example, determine how the pet monitoring device 12 responds to situations, set a boundary or virtual fence for the dog, tune the bark control module 59, set a location identification procedure and determine how data received at the data centre 16 will be communicated to or accessed by the authorised user. For example, the authorised user 22 can set a detection sequence for identifying the location of the dog in response to a command transmitted to the pet monitoring device 12 via the mobile telecommunications network.

In one example of use of the pet monitoring device 12, the authorised user 22 cannot find the dog 14. In consequence the authorised user 22 causes a command to be sent to the data centre 16 via the internet 24 for onward transmission to the pet monitoring device 12 via the mobile telecommunications network 20. The command is received via the cellular telephone 46 and processed by the processor 40. In response to the command the processor 40 attempts to determine the location of the pet monitoring device 12 using GPS tracking. If signals from GPS satellites can be obtained, coordinates identifying the location of the pet monitoring device can be determined and the processor 40 causes a signal containing data representative of the location to be transmitted to the data centre 16 via the mobile communications network 20. The authorised user 22 is able to access the data and use it to display the location of the pet monitoring device 12 using, for example Google Maps™. According to the setting of the pet monitoring device 12, updates on the location may be generated automatically, or the authorised user can send further enquiry commands, and the updated location data transmitted by the pet monitoring device can be used to track the pet monitoring device on the communications device 26. In the event GPS tracking is not possible, the processor 40 may automatically switch to using signal parameter data to identify the location of the pet monitoring device 12. In addition, the pet monitoring device 12 may transmit data representative of images or sounds captured by the image capturing device 52 or sounds capturing device 54. Even if the authorised user 22 does not need images or sounds to identify the location of the dog, images or sounds may be helpful to the authorised user for judging whether the dog is, for example, distressed.

While attempting to recapture a dog that has strayed, the authorised user 22 may use the pet monitoring device 12 to soothe the dog by causing pre-recorded messages to be output from the speakers. Alternatively, spoken messages may be transmitted in the real time to the pet monitoring device 12 via the data centre 16 and mobile communications network 20. If there is an indication the dog is barking, the authorised user 22 may cause the speakers 68 or ultrasound emitters 70 to output stimuli to encourage the dog to cease barking.

In some examples, the bark detection module 59 is activated and if barking is detected, a signal containing data representative of a barking alert is sent to the data centre 16 via the mobile telecommunications network 20. This may automatically be forwarded to the authorised user 22. In response, the authorised user 22 may cause commands to be transmitted from the communications device 26 to the data centre 16 for onward transmission to the pet monitoring device 12 over the mobile communications network 20. The commands may cause the processor 40 to activate the stimulus output device 56 to output stimuli to encourage the dog to cease barking. Alternatively, the processor 40 may automatically activate the stimulus output device 56 in response to a detection of barking by the barking detection module 59.

The bark sensor module 59 is described as being a three axis gravity sensor. This is not essential. Sounds detected by the sounds capturing device 54 may be used for bark sensing. For example, certain frequencies, or patterns, may be taken as indicative that the dog is barking and the processor 40, or a processor or suitable circuitry incorporated in the bark sensor module 59, configured to detect those frequencies, or patterns, to determine when the dog is barking.

In the illustrated examples, the pet monitoring device 12 comprises a dog collar. In principle, the pet monitoring device may comprise a collar configured so as to be suitable for fitting to other species of pet, for example a cat. Also, the pet monitoring device may take other forms. For example the pet monitoring device may comprise a coat, or jacket, that can be worn by a dog. It will be understood that the primary requirement is that the pet monitoring device can be securely fitted to a pet such that it will not become separated from the pet while in normal use and will not be burdensome to the pet. In cases in which the pet monitoring device is not intended for use on a dog, it may be considered unnecessary to have a bark sensor module, although, in some examples, a module configured to detect when the pet is giving out audible indications of distress may be implemented.

While the authorised user will typically be a pet owner, the authorised user may instead be a person providing pet care for pet owners, such as a kenneling or dog walking service. The authorised user may be a legal entity or one or more natural persons. In each case, the locating or control functionality obtainable with examples of the pet monitoring device may be used to advantage.

1. A pet monitoring device to be fitted to a pet that is to be monitored, said pet monitoring device comprising a transmitter configured to transmit signals via a mobile telecommunications network whereby the location of the pet monitoring device can be determined by reference to parameters associated with receipt of a said signal by at least one base station of said mobile telecommunications network so that an authorised user can identify the location of the pet monitoring device.

2. A pet monitoring device as claimed in claim 1, further comprising GPS enabling circuitry whereby the location of the pet monitoring device can be determined by GPS tracking.

3. A pet monitoring device as claimed in claim 1, further comprising a processor configured to determine the location of the pet monitoring device and cause the sending of a signal containing data identifying said location via said mobile telecommunications network for access by said authorised user.

4. A pet monitoring device as claimed in claim 3, wherein said signal containing data is transmitted over said mobile telecommunications network by said transmitter to a data centre for onward transmission to or access by said authorised user.

5. A pet monitoring device as claimed in claim 1, further comprising at least one of:
an image capturing device, wherein said transmitter is configured to transmit signals containing data representative of images captured by said image capturing device for access by said authorised user whereby said authorised user can display the captured images to identify the location of the pet monitoring device; and
a sounds capturing device, wherein said transmitter is configured to transmit signals containing data representative of sounds captured by said sound capturing device for access by said authorised user whereby said authorised user can obtain an audio output of the captured sounds to identify the location of the pet monitoring device.

6. A pet monitoring device as claimed in claim 5, further comprising memory to store data representative of said captured images or said captured sound.

7. A pet monitoring device as claimed in claim 5, wherein said signals containing data representative of images or sounds are transmitted over said mobile telecommunications network by said transmitter to a data centre for onward transmission to or access by said authorised user.

8. A pet monitoring device as claimed in claim 1, further comprising a receiver configured to receive signals caused to be sent by said authorised user via said mobile telecommunications network and a stimulus output device to output stimuli to the pet in response to commands contained in said signals.

9. A pet monitoring device as claimed in claim 8, wherein said stimulus output device is configured to output acoustic stimuli to the pet, said acoustic stimuli comprising at least one of ultrasonic sound and a voice message.

10. A pet monitoring device as claimed in claim 8, further comprising a processor configured to permit adjustment of the output stimuli whereby said authorised user can associate a particular stimuli with a particular said command to permit customisation of said output stimuli by the authorised user.

11. A pet monitoring device as claimed in claim 1, further comprising a bark detection module.

12. A pet monitoring device as claimed in claim 11, wherein said transmitter is configured to transmit signals containing data indicating that the pet is barking via said mobile telecommunications network.

13. A pet monitoring device as claimed in claim 11, further comprising a bark detection module and configured such that said stimulus output device automatically outputs stimuli to said pet in response to a detection of barking by said bark detection module.

14. A pet monitoring device as claimed in claim 1, further comprising a collar by which the pet monitoring device can be fitted to said pet that is to be monitored.

15. A pet monitoring device to be fitted to a pet that is to be monitored, said pet monitoring device comprising a transmitter configured to transmit signals via a mobile telecommunications device, said signals being configured to allow an authorised user to identify the location of the pet monitoring device and said location being identified by at least one of:
i) GPS tracking;
ii) reference to parameters associated with receipt of a signal transmitted by said transmitter and received by at least one base station of said mobile telecommunications network;
iii) images of said location; and
iv) audio capture from said location.

16. A pet monitoring device as claimed in claim 15, further comprising a processor configured to determine said location by GPS tracking or reference to said parameters associated with receipt of said signals and cause transmission of a signal containing data identifying said location via said mobile telecommunications network for access by said authorised user.

17. A pet monitoring system comprising:
a pet monitoring device to be fitted to a pet that is to be monitored; and
a data centre,
wherein said pet monitoring device comprises a transmitter configured to transmit signals via a mobile telecommunications network,
said data centre is configured to receive said signals and provide an authorised user with access to data contained in said signals, and
said data enables said authorised user to identify the location of said pet monitoring device, said location being identified by a least one of:
i) GPS tracking;
ii) reference to at least one parameter associated with a signal transmitted by said transmitter and received by at least one base station of said mobile communications network;
iii) images of said location; and
iv) audio capture from said location.

18. A pet monitoring device as claimed in claim 17, wherein said pet monitoring device comprises GPS enabling circuitry whereby said data comprises GPS data so that an authorised user can identify the location of the pet monitoring device by GPS tracking.

19. A pet monitoring system as claimed in claim 17, wherein said pet monitoring device further comprises at least one of:
an image capturing device and said transmitter is configured to transmit signals containing data representative of images of said location captured by said image capturing device whereby said data comprises captured images so that said authorised user can identify the location of the pet monitoring device by reference to said images; and
a sounds capturing device and said transmitter is configured to transmit signals containing data representative of sounds captured by said sound capturing device whereby said data comprises audio capture so that said authorised user can identify the location of the pet monitoring device based on an audio output.

20. A pet monitoring system as claimed in claim 17, wherein said data centre comprises a processing system configured to:
i) permit said authorised user to make a remote connection to access said data;
ii) forward said data to said authorised user; and/or
iii) transmit alerts to said authorised user.

21. A pet monitoring system as claimed in claim 17, wherein the pet monitoring device comprises a receiver configured to receive signals transmitted via said mobile telecommunications network and a stimulus output device to output stimuli to the pet in response to commands caused to be sent by said authorised user in said signals received by said receiver.

22. A pet monitoring system as claimed in claim 21, wherein said stimulus output device is configured to output acoustic stimuli to the pet, said acoustic stimuli comprising at least one of ultrasonic sound and a voice message.

23. A pet monitoring system as claimed in claim 21, wherein the pet monitoring device comprises a processor configured to permit adjustment of the output stimuli whereby said authorised user can associate a particular stimuli with a particular said command to permit customisation of said output stimuli by the authorised user.

24. A method of monitoring a pet, said method comprising:
attaching to a pet a pet monitoring device that comprises a transmitter configured to transmit signals via a mobile telecommunications network;
receiving signals from said transmitter via said mobile telecommunications network, said signals containing data by which the location said pet monitoring device can be identified by an authorised user,
wherein said location is identified by a least one of:
i) GPS tracking;
ii) reference to at least one parameter associated with a signal transmitted by said transmitter and received by at least one base station of said mobile telecommunications network;
iii) images of said location; and
iv) audio capture from said location.

25. A method of monitoring a pet as claimed in claim 24, wherein said signals that contain data are received by a data centre that comprises a processing system configured to:
i) permit said authorised user to make a remote connection to access said data;
ii) forward said data to said authorised user; and/or
iii) transmit alerts to said authorised user.

26. A method of monitoring a pet as claimed in claim 24, further comprising receiving a signal from said transmitter via said mobile telecommunications network that contains data indicating said pet is barking and transmitting a signal to said pet monitoring device via said mobile telecommunications network which signal contains a command that causes a stimulus output device of said pet monitoring device to output a stimulus to encourage the pet to cease barking, wherein said stimulus comprises at least one of:
i) an ultrasound emission; and
ii) a voice message.
